(19) United States
(12) Patent Application Publication
(10) Pub. No.: US 2007/0255623 A1
(43) Pub. Date: Nov. 1, 2007

(54) Interactive food-and beverage preparation and wine-making system and method

(75) Inventors: Vladimir Firer, San Mateo, CA (US); Gregory D. Snell, San Jose, CA (US)

Correspondence Address: Vladimir Firer, 3345 Los Prados Street, San Mateo, CA, 94403, US

(73) Assignee: Provina Incorporated

(21) Appl. No.: 11/414,251

(22) Filed: Apr. 27, 2006

(51) Int. Cl. G06Q 30/00; G06Q 50/00

(52) U.S. Cl. 705/15

(57) ABSTRACT

An interactive food- and beverage preparation or wine-making system that contains a computerized food-processing device, e.g, a wine-making press that is equipped with appropriate executing mechanisms and sensors and with a central processing unit provided with a program that controls the process and in response to outputs of executing mechanisms and/or sensors request the user to check the quality of the product by using at least one human sense selected from the group consisting of a sense of taste, visual evaluation, sense of smell, and sense of touch of said food, beverage, or wine. The invention also relates to a method for preparing food and beverages, or making a wine by means of the aforementioned system.

### FIELD OF THE INVENTION

The present invention relates to the field of food and beverage preparation, wine making, in particular, and to a computerized interactive system and a method for use in such fields as wine making.

### BACKGROUND OF THE INVENTION

In general, the preparation of food is a multiparametric process that involves a great number of parameters, such as temperature, duration, temperature variations in the process of cooking, pressure, humidity, concentration and composition of ingredients, etc. Moreover, even in cooking food of the same type, the results may vary in a wide range. On the other hand, in view of the great variety of choices and people's tastes, the same food may seem to be delicious for one person and tasteless to another. This means that in order to satisfy the requirements of the individual, food cooking and preparation processes can be automated with the computers, embedded processors, personal digital assistants (hereinafter PDAs), etc. only to a limited level such that a human factor has to be involved in the process. However, by using purely automatic processes, it is impossible to satisfy the tastes and choices of all possible consumers of the final food or beverage.

The above said is especially true for wine making which is a field based on old traditions, where evaluation based on human factors is extremely subjective and depends on personal tastes and customs of the evaluators. Even in those cases where the characteristics of wines are well specified for quality evaluation, exact reproduction of the wine with the same unique properties is practically impossible. Even for the wines having the same origin, due to effect of such factors climatic changes from year to year and their influence on the grape harvest quality, it is impossible to recreate the exact same tastes and properties. Preparation of a wine that will match the taste of the consumer is especially problematic for small local wineries and home wine producers.

There exists a tremendous amount of literature relating to food and beverage making instructions. Recent developments including the use of computers and the Internet further expanded access to data bases that contain the relevant literature but the search of specific literature needed for the user requires significant time and knowledge in searching. This is especially true for beginners.

Attempts have been made to facilitate preparation of food and beverages with the use of computers, that may facilitate the search of recipes, adjust food preparation processes, help to teach or learn food preparation steps, etc.

For example, U.S. Pat. No. 5,832,446 issued in 1998 to Thomas Neuhaus describes an interactive database method and system for food and beverage preparation. The invention features a computerized, electronic cooking encyclopedia running on Sun SPARC stations. The computerized system and method provide a search tool for accessing information about a worldwide variety of foods and beverages. The program of the invention allows for searching recipes by culture, menu category, preparation method and ingredients. Information is provided about the degree of complexity, necessary equipment, cooking tips, any caveats proffered and restaurants that actually serve a given dish (along with their menus). The software includes accessing an extensive database having color illustrations. When a CD ROM video or audio library is accessed, animation and/or audio viewing and listening are made possible.

U.S. Pat. No. ______ issued in 2004 to Michael Woods et al. describes and interactive learning appliance and a method for assisting a user in learning.

Although processing of food and cooking constitutes only one of objects of this invention, the method may be applicable to such fields and consists of receiving performance information of a user after the user uses an interactive learning appliance. The user performance information is generated by the user's use of the interactive learning appliance which is adapted to educate the user about one or more predetermined subjects. The performance information, which may be in the form of a user log file, may be received at a server computer from a site where the user is present. Exemplary user profile information may include information such the user's age, hobbies, address, phone number, e-mail address, school, favorite subjects, relatives, teachers, favorite songs, favorite sports; favorite foods, favorite cartoons, etc.

US Patent Application Publication No. 20050040051 published in 2005 (applicant Christine Martin) discloses a method and kit for teaching home cooking, food and wine pairing, and entertaining. The package may contain any items necessary to teach the preparation and arranging of the dining experience. Further, the package can contain instructions and lists of perishable food items which may be needed for the dining experience. One preferred embodiment of the method of teaching home chefs through interactive cooking instructions in accordance with the present invention provides each home chef with instructions, including pages each having printed thereon one or more instructions as detailed above. In a further embodiment, the instructions may also have the shopping list for any of the items from the recipe which are not included, an itemized list of what is included in the kit, and any other information helpful or of interest to the home chef for that particular kit. Further, advertisements for web sites, books, stores or any other information pertinent to that specific kit may also be included. For example, for a kit which is specific for Indian food, advertisements for websites which may be used to purchase more Indian spices, music, books, and products may be included. Further, advertisements for similar kits may be included.

US Patent Application Publication No. 20020026363 published in 2002 (Applicant Harold Dunaway) relates to an online data processing implemented system and method which provides remote culinary preparation services by personal chefs. The delivery of the present system also contains novel business methods. A critical enabler of the present invention is its incorporation of and adaptation to a web based infrastructure common to computer networks such as the Internet. The website centric business model of the present invention greatly enhances a chef's productivity by providing for enhanced and more efficient communications, shopping list preparation, scheduling, and management. Additionally, links to a home grocery delivery service may be included to further enhance the efficiencies of the present invention. In addition to supporting a more efficient business model, the present invention will also provide the marketing necessary to increase consumer awareness of the benefits and affordability of personal chef service. Individual personal chefs simply do not have the time, resources or business skills to fully exploit the industry's growth potential. Moreover, by providing business management tools such as scheduling, payroll and on-line training the system and method of the present invention will enable rapid expansion of the business with low overhead in each individual market.

U.S. Pat. No. 6,837,148 issued in 2005 to Laurent Deschenes describes a cooking aid device. The invention relates to a device for assisting in culinary preparation, comprising a plurality of electric household appliances and a remote monitoring and control apparatus. According to the invention, the user can select a prerecorded culinary preparation that is modeled as a sequence of steps of preparation and, in the course of at least one step, the monitoring and control apparatus receives a condition signal SE from certain of the electric household appliances, and emits toward certain others a control signal SC dependent on the one hand on condition signals SE and on the other hand of prerecorded operational parameters.

However, none of the aforementioned references including those which are the inventors herein are aware of describes a cooking or food preparation system and method that is based on active interaction between the user and the computer-aided food preparation or cooking equipment in order to obtain the results closely matching the user's tastes and requirements.

### OBJECTS

To provide a simple and user-friendly interactive food- and beverage-preparation system that assists the user in preparation of food and beverages of different types by combining automated control of the process with the use's input and/or predefined knowledge data base. Another object is to provide a method for preparing food, beverages, or for making a wine in an interactive mode with the user and by indispensably including into the process the use of the user's senses such as vision, sense of taste, sense of smell, or a sense of touch. Still another object is to provide a computer-aided system and method of making a high-quality wine by an inexperienced user in an interactive mode with the user and involving, in addition to automated processes, an input from the user's senses such as the taste of wine, smell of wine, visual evaluation of wine, or sense of touch.

### BRIEF DESCRIPTION OF THE DRAWINGS

FIG. 1 is a block-diagram view of a food, beverage, and wine preparation system of the invention.

FIG. 2 is a flow chart illustrating a method of the invention for the preparation of food, beverage, and wine by using the system of FIG. 1.

FIG. 3 is a flow chart illustrating application of the method of the invention for making wine.

### SUMMARY

The system consists of: one or several food-processing devices having appropriate executing mechanisms such as mixing rotors, heaters, coolers, and control unit with appropriate sensors, thermoelectric cooler, heater, or a combined thermoelectric cooler-heater 26; stand-alone or embedded central processing unit such as computer, microprocessor, PDA, etc. connected to the elements of the aforementioned control unit; an output device connected to the central processing unit, such as a visual or a sound terminal; and an input device connected to the central processing unit. Loaded into the central processing unit is a program that contains a predefined sequence of commands, steps, and data relating to the functions of the system. The program provides automatic operation of the executing mechanisms, reads data from the sensors, and if necessary, asks the user appropriate questions. According to one embodiment of the invention, the system and method of the invention are applied to a home wine-making system that contains a tank for a wine must, cooler and heaters for the tank, a central processing unit with an appropriate program, sensors that sense the temperature and other characteristics of the must, etc. The user loads the must into the tank of the system, and the fermentation process is started. During the fermentation process the sensors reads the must parameters such as temperatures, a pH value, and a sugar content, and put appropriate questions to the user, such as “Check the smell of the must and select from the list of predefined smells!”, or “Taste the must and select from the list of predefined tastes”. or “What percentage of alcohol is needed?”. Based on the data read out from the sensors and on the user's selection, the program either sends commands to the executing mechanisms for appropriate action, e.g., increase or decrease of temperature, or recommendations, such as “Add 3 g of yeast!”. Furthermore, the program issues an extended explanation of the recommendation or choices that may be shown on the display or printed out. All parameters of the process, including commands and recommendations are recorded in a computerized user-friendly wine-making journal.

### DETAILED DESCRIPTION OF THE INVENTION

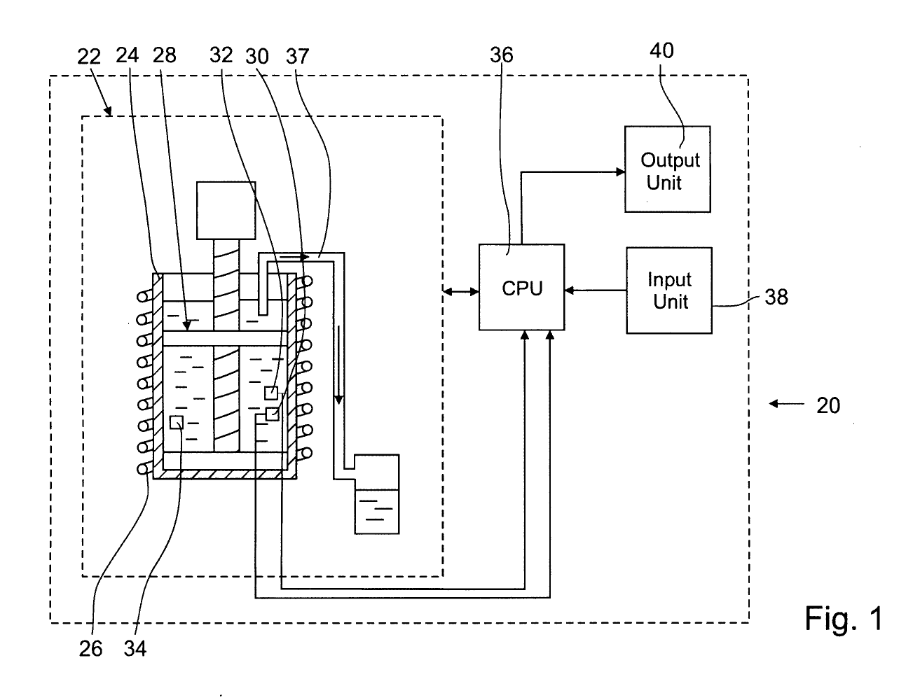

An example of a system of the invention, which as a whole is designated by reference numeral 20 is shown in a block-diagram form in FIG. 1. The system 20 contains a food-processing device (there may be several such devices in the system 20, although one is shown for simplicity), e.g., a wine-making machine 22 in the form of a fermentation tank 24 having appropriate executing mechanisms such as a thermo-electrical heater-cooler thermoelectrical cooler, heater, or a combined thermoelectric cooler-heater 26 (hereinafter referred to as the cooler-heater 26), press mechanism 28 for squeezing the must, appropriate sensors, such a sugar-content sensor 30, temperature sensor 32, and a pH sensor 34, or the like. Reference numeral 37 designates a siphon for sucking out the wine.

The system further contains a central processing unit 36 (herein after referred to as CPU) such as a computer microprocessor, PDA, etc. connected to the aforementioned executing mechanisms, i.e., to the thermo-electrical heater-cooler 26, press mechanism 28, sugar-content sensor 30, temperature sensor 32, and the pH sensor 34. The CPU may be a stand-alone unit or can be built into the structure of the food processing device 22.

Other units associate with the CPU 36 are a data input unit 38 such as a keyboard, a data output unit 40 such as a display unit for presenting a visual information about the process to a user that may also be connected to an acoustic alarm unit for use as a warning device.

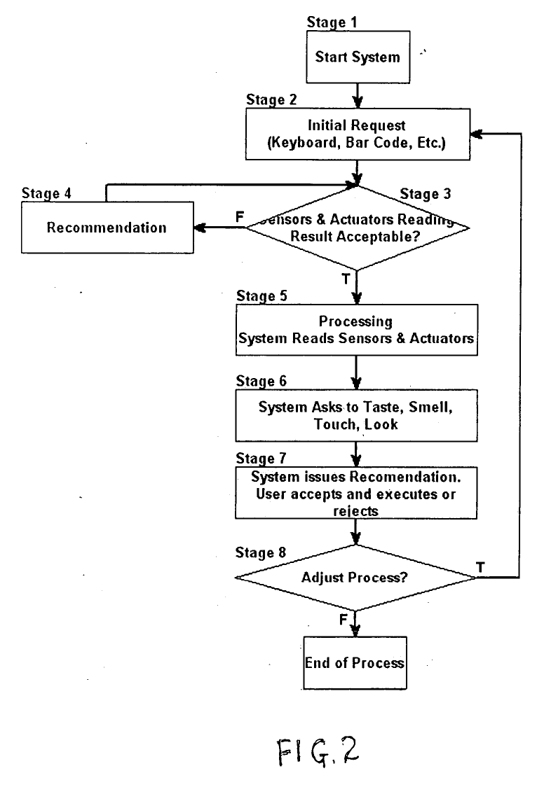

A distinguishing feature of the system 20 off the invention is a program that is shown below in the form of a flow charge (Chart?) in FIG. 2 for controlling and monitoring operation of the wine-making machine 22. The aforementioned program and method of the invention will be considered later after consideration of some specific feature and examples of the components of the system shown in FIG. 1.

The wine-making machine 22 may be comprised of a known industrial or a consumer-type aided apparatus suitable for the purposes of the invention.

One such apparatus is disclosed in U.S. Pat. No. 4,856,421 issued in 1989 to D. Whitford. The apparatus is equipped with a computer-controlled fermentation means for controlling the content of a specific component of a wine produced by the apparatus and for adding an appropriate amount of the component when deficiency thereof is determined by an appropriate sensor.

The thermo-electrical heater-cooler 26 may be represented by , , , , and made in the form of a coil wound around the fermentation tank 24.

The press mechanism 28 may be of the type used in a wine making apparatus shown in Published US Application No. 20040076713 published in 2004 and filed by T. Lorincz.

The sugar-content sensor 30 may use a sensitive element of a device known in the industry as a Brix meter. For example, Kyoto Electronics Manufacturing Co, Ltd (KEM) manufactures the Check-Brix RA-250HE Portable Digital Brix Meter designed for quick and accurate sugar content measurements (BRIX) of wines, fruits, foods, drinks, etc.

The temperature sensors and pH meters are well known in the art and are available in a wide range of selections. For example, the temperature sensor 32 known as thermistor ON-900 and a pH sensor 34 known of pH-Meter PHE1304, both available from by Omega Engineering, CT, USA.

The CPU 36 may be represented by a microcontroller of the type CY3635 manufactured by Cypress Semiconductor that can be built into the structure of the wine-making machine 22 and that may have its own liquid-crystal display.

Having described the structure of the system 20 of the invention and its components, let us consider the method of the invention which is based on the use of a process of cooking food, preparing a beverage, or making a wine in a manner of interaction of the food preparation device, e.g., the wine-making machine 22, with the user of the machine via the response of the sensors 30, 32, 34, and executing mechanisms, such as, e.g., the press 28, the cooler-heater 26, through the CPU 36, the aforementioned interaction involving the use of at least one human sense selected from vision, sense of smell, tactility, and sense of taste. The use of the aforementioned at least one human sense is an indispensable condition of the method of the invention.

The method of the invention will be described with reference to FIG. 2 which is a flow chart of one cycle of a computerized operation of the system of FIG. 1.

First the apparatus 22 is loaded with an appropriate ingredients (not shown), and the program is loaded into the CPU 36. The program is intended for a specific cooking, beverage preparation, or a wine-making process.

At stage ST1 the apparatus is activated, i.e., the aforementioned executing mechanisms and sensors are energized. At stage ST2 the CPU36 puts a question to the user on the display 40 regarding a type of product the user wish to make and parameters of the target product, and the user makes his/her output through the input unit 38.

After the user made his/her selections at Stage ST2, the system 20 begins to check outputs of all the sensors and executing mechanisms. At Stage ST3 the system displays the results of sensor and mechanism checking and asks the user if the results are acceptable. If the answer is YES, the system proceeds to Stage ST5 where the apparatus begins the process of cooking food, preparing a beverage, or making a wine. If the answer at Stage ST3 is NO, the system prompts for the action (Stage 4), and after an appropriate action, the Stage ST3 is repeated, if necessary, several times until the answer YES is obtained.

In Stage ST6, after a certain pre-selected time of operation or based on the results of measurements by the sensor or sensors, the system asks the user to check the product by using at least one of humans senses such as vision, sense of taste, sense of smell, or tactility. Examples of the questions are the following: “Taste the Product and Select One Taste from the List” (Such a list may contain statements like “Too salty”, “Too sweet”, etc.), “Smell the Product” (Such a list may contain statements like: “Fruity Smell”, “Aromatic”, etc.; “Observe the Appearance of the Product” (Such a list may contain characteristics like “Color”. “Transparency”, etc.); and “Touch the Product” (Such a list may contain characteristics like “Too tacky”, “Low Viscosity”, etc.). At Stage ST7, the system issues recommendations with explanations such as “Add 15 g of sugar”, “Add 0.5 liter of water”, “Increase the temperature by 15° C. for 30 min. of cooking”, etc.

After Stage ST7, on stage ST8 the system may return back to Stage ST2 since based on the results of recommendations the user may even decide to change the characteristics of the target product, and after the input, if any, the system continuous the operation passing through the stages from ST2 to ST8, until the system confirms that the target product is ready and the system can be switched off.

The methods shown above were described with reference to the most general case that covers preparation of foods and beverages of different types. The method and the apparatus of the invention will be further described with reference to a specific example of wine making.

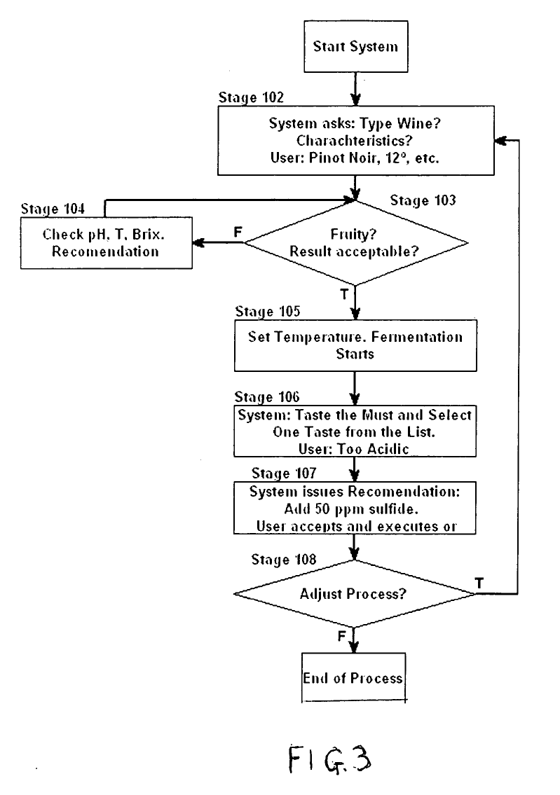

The system and method of the present invention relating to the case of manufacturing a wine is described below with reference to FIG. 3 which is a flowchart of the process.

Let us assume that wine which is intended for the production is a Pinot Noir type wine which was produced by using the Pinot Noir fruit from the 2005 vintage.

First, the fermentation tank 24 of the apparatus 22 is loaded with a predetermined amount of the grape, and the wine-manufacture program (which is disclosed in terms of the flowchart of FIG. 3) is loaded into the CPU 36. The program is intended specifically for wine making.

At stage ST100 the apparatus is activated, i.e., the aforementioned executing mechanisms such as the heater-cooler 26 and the sugar-content sensor 30, temperature sensor 32, and the pH sensor 34 are energized.

At stage ST102 the CPU36 puts a question to the user on the display 40 regarding a type of wine the user wish to make and regarding parameters of the target wine, and the user makes his/her choice through the input unit 38 by selecting, e.g., the Pinot Noir type. In response to the selection that is inputted through the keyboard 38, the system 20 requests the user on stage ST103 to further select the characteristics of the target wine: such as “spicy—YES or NO” and “fruity—YES or NO”. Let us assume that in both cases the answer is YES. If necessary, the system 20 may continue interaction with the use with regard to selection of other specific properties of the target wines, such as content of alcohol in the target wine, etc.

After the user made his/her selections at Stage ST103, the system 20 begins to check outputs of all the sensors and executing mechanisms, i.e., the temperature of the must measured by the temperature sensor 32, the content of sugar measured by the sugar-content sensor 30, the value of pH measured by the pH sensor 34, and the status of the heater-cooler 26.

At Stage ST104 the system displays the results of the sensor and mechanism check and asks the user if the results are acceptable. Since there is a certain relationship between the percentage of alcohol in a wine and the potential alcohol of the wine, the system 20 checks the existing content of the sugar over the selected content of alcohol, and in case of inconsistency, the system can make an appropriate suggestion.

If all the requirements are satisfied, at Stage ST105 the user sets the temperature, and the fermentation process is started at stage ST106. During fermentation the sugar is converted into alcohol, and in response to outputs from the sensors, or in predetermined time intervals, the system 20 asks the user to check the product by using at least one of the human senses such as vision, sense of taste, sense of smell, or tactility. Examples of the questions are the following: “Taste the Product and Select One Taste from the List” (Such a list may contain statements like “Too sweet”, “Too acidic”, etc.), “Smell the Product” (Such a list may contain statements like: “Nail-Polish”, “Aromatic”, etc.; “Observe the Appearance of the Product” (Such a list may contain characteristics like “Color”. “Transparency”, etc.); and “Touch the Product” (Such a list may contain characteristics like “Too tacky”, “Low Viscosity”, etc.).

At Stage ST107, the system issues recommendations with explanations such as “Add 50 ppm sulfide”, etc.

After Stage ST107, on stage ST108 the system may return back to Stage ST102 since based on the results of recommendations the user may even decide to change the characteristics of the target wine, and after the input, if any, the system continues the operation passing through the stages from ST102 to ST108, until the system confirms that the target wine is ready and the system can be switched off.

The system and method of the invention will be further described by way of a comparative application example given below. Comparison of two winemaking methods applied to 2005 Sangiacomo Roberts Road Pinot Noir Block #21

The application example is based on winemaking practices and results using the system 20 of the invention, hereinafter referred to as the WinePod in comparison to a traditional winemaking method disclosed in the Comparative Example given below. Both methods used the exact same fruit from the same vineyard block. The WinePod method used comparatively less labor and produced a superior wine.

### APPLICATION EXAMPLE

Details: Grapes were picked from the Sangiacomo Roberts Road vineyard at Block #21 on Oct. 14, 2005 and delivered to Greg and Greg Custom Crush facility in Sebastopol Calif. Grapes were then sent to the crusher destemmer. Grapes were destemmed only with 100% whole berries. As picked data was 25 brix, pH 3.5, TA 0.65. Grapes were then transported to San Jose Calif.

Two winemaking apparatuses were used in creating the Pinot Noir. The first system, the “WinePod”, which correspond to the device 22 in FIG. 1, is a thermoelectric temperature controlled unit with submerged cap, automatic melior style press 28, sugar content sensor 30 (hereinafter referred to as “Brix”, a temperature sensor 32, and a pH sensor 34. The second system, the “traditional method” was a large plastic bucket and manual basket press with temperature monitoring only.

Description of WinePod Batch:

The WinePod 22 utilizes a stainless steel tank with stainless lid. The lid houses the Brix sensor 30 and submerged cap assembly. The tank 24 and all wetted components, included the above mentioned lid assembly, was sterilized with Vodka and Sulphite. Three 20 liter buckets of grapes were added to the WinePod 22 at 10 μM on Oct. 15, 2005. The grapes had been maintained at 10° C. overnight. The WinePod temperature was set at 10 C for “cold soaking” and 25 ppm of Sulphite was added to the must. The Brix, temperature, and pH were monitored with an alarm set point when the pH is at 3.6. In response to the request of the system 20 to the user, the lid was opened once per day and the wine was stirred and checked daily by tasting, smelling, observing, or touching the must.

Based on one of the program recommendations, on the third day of cold soaking, we noticed that at the surface of the must near the corner of the lid, there was a rainbow surface on about 3-5 grapes. The term “rainbow surface” triggered bacterial contamination. We removed those grapes and added another 25 ppm of sulfite. The cause was a lack of insulation on the lid. We added insulation and the problem did not return.

After about 10 days of cold soaking, on the day of Oct. 24, 2005, in accordance with recommendation of the system 20 the Wine Pod temperature was allowed to raise naturally. Based on the system recommendations and calculations, the lid was opened up and 50 grams of BM-45 yeast and 30 grams of DAP and nutrients was added to the must. Within 20 hours, the Brix had dropped from 25 to 20, indicating the fermentation had begun. During this same period the pH rose from 3.53 to 3.62 and triggered an alarm. Six liters of water and 50 grams of tartaric acid were added to the must in order to lower the acidity and lower the potential alcohol of the finished wine. Based on the system recommendations and input through the keyboard 38 from the user who tasted the must, the lid was opened once per day and stirred. The need for punchdowns was eliminated by the use of the submerged cap. The smell and taste of the wine were fruity and effervescent, respectively. The system defined these properties as normal for fermentation.

On October 27 at 4 PM, the Brix was −2.39 and the lid was removed. The press operation was initiated with the automatic melior style press 28. The press was slowly operated with pressures recorded up to 750 pounds (limit of the sensor). However, press pressures were much higher, probably up to 2,000 pounds or more. The pomace was reduced to about 3 inches in depth and no more liquid was coming out of the system. The wine was then siphoned through the siphoned 37 into two five-gallon carboys with some residual wine going into another vessel. The wine was extremely clear. It was also slightly sweet indicating that the whole berries still had some residual sugar in them that was not measurable from the brix sensor. The carboys were then filled with about fifty French oak 1 cm cubes each.

After a few weeks, the wine smelled like rotten eggs. This word triggered hydrogen sulfide in our interactive winemaking system 20. It instructed us to rack the wine, but the smell did not go away. We were prompted to do another test because the racking did not work. We performed a test to determine if it was truly hydrogen sulfide. The test called for us to put a small amount of copper sulfate in a 100 ml sample of wine and another 100 ml in a control sample of wine. The wine with the copper sulfate did not have the smell completely removed, but it was greatly reduced so we were prompted to add another step to the test. We added 30 ppm of ascorbic acid to the wine prior to the copper sulfate and it completely removed the smell. This prompted us to then determine the proper amount of Copper sulfate by adding incrementally 0.2 ppm to the 100 ml sample. After 5 additions, the smell was gone. Therefore, we determined that 1 ppm was the proper amount. We then added 30 ppm ascorbic acid and 1 ppm Copper sulfate to the 10 gallons of wine.

### COMPARATIVE EXAMPLE

On October 14, (3) twenty-liter sterile buckets were put into a sterilized plastic tub. In order to keep the temperature at 1° C., 10 pounds of dry ice was added to the must and a plastic tarp was put on the cover to keep it clean. We installed a temperature sensor in the must to make sure that the temperature stayed below 10 C. As a result, we added about 3-5 pounds of dry ice every day.

A pH sample was taken every day to determine if the pH was below 3.6. We added 6 liters and 50 grams of tartaric acid to the must.

On October 24, we stopped adding dry ice and pitched the BM-45 yeast. The plastic drum was lifted on one corner and a heating pad was added to initiate the fermentation. Within two days, the fermentation was initiated. The temperature peaked at 92 F even though we were punching down the cap 4 times per day. It was difficult to control the temperature from going too high. Each day we sampled the brix. On October 27, the wine was nearly dry. On October 28, we began the press. The wine was scooped out of the tank and put into the basket press manually. The wine was very murky because the transfer of the wine into the press stirred up the sediment and seeds on the bottom. We pressed as hard as we could, but felt there was still good structured wine in the pomace.

We moved the wine into (2) five-gallon carboys with some extra wine in a one gallon jug. We added oak chips to the bottles. Because of the heavy sediment, we had to rack several times and the wine was still unclear 3 months after pressing unlike the WinePod wine.

Subjective Wine Sensory Evaluation:

We tasted both wines blind in March 2006. Everyone agreed that the WinePod wine had better structure, fruitiness and better clarity. We attributed this to the press and the strict temperature control. If we had not been prompted to add our sensory evaluation to the winemaking, the bacterial spoilage from the “rainbow surface” and the “rotten egg” smell would have significantly lessened the sensory evaluation of the wine.

Thus, it has been shown that the invention provides a simple and user-friendly interactive food- and beverage-preparation system that assists the user in preparation of food and beverages of different types by combining automated control of the process with the use's input and/or predefined knowledge data base. The invention provides a method for preparing food, beverages, or for making a wine in an interactive mode with the user and by indispensably including into the process the use of the user's senses such as vision, sense of taste, sense of smell, or a sense of touch. Furthermore, the invention provides a computer-aided system and method of making a high-quality wine by an inexperienced user in an interactive mode with the user and involving, in addition to automated processes, an input from the user's senses such tasted of wine, smell of wine, visual evaluation of wine, or sense of touch.

Although the invention has been described with reference to specific embodiments of the system and method, it is understood that the application of the invention is not limited to these specific embodiments and that any modifications and changes are possible with regard to the starting components of the food, beverage, or wine, types of food preparation devices, executing mechanisms, sensors, etc. For example, the food preparation device may comprise a mixer, oven, stove, or the like. The cooler and heater may be not of a thermoelectric type but a Freon-compressor type.

1. An interactive food- and beverage preparation and wine-making system for preparing food, beverage, or wine in an interactive mode with a user, comprising:
a food-processing device comprising: at least one executing mechanism for processing said food, beverage, or wine;
a central processing unit connected to said at least one executing mechanism;
a data input unit connected to said central processing unit;
a data output unit connected to said central processing unit; and
a program incorporated into said central processing unit that contains a set of commands to said system and instructions to said user for evaluating said food, beverage, or wine by involving at least one human sense selected from the group consisting of a sense of taste, visual evaluation, sense of smell, and sense of touch of said food, beverage, or wine.

2. The system of claim 1, wherein said food processing device is a wine-making machine.

3. The system of claim 2, wherein said at least one executing mechanism is selected from the group consisting of a cooler, a heater, a cooler-heater, and a press.

4. The system of claim 3, further comprising at least one sensor for measuring characteristics of said food, beverage, or wine, said at least one sensor being selected from the group consisting of a temperature sensor, a sugar-content sensor, and a pH sensor.

5. The system of claim 1, wherein said data processing unit is selected from the group consisted of a computer, an embedded micro-processor, and a PDA.

6. The system of claim 5, wherein said data input unit is a keyboard and said data output unit is a display.

7. The system of claim 4, wherein said data processing unit is selected from the group consisted of a computer, an embedded micro-processor, and a PDA.

8. The system of claim 7, wherein said data input unit is a keyboard and said data output unit is a display.

9. The system of claim 6, wherein said instructions comprises a set of questions displayed on said display.

10. A method for preparing a food or beverage or making a wine by means of a computerized system and in a manner of interaction with a user, comprising the steps of:
providing a computerized system for preparing a food or beverage or making a wine that contains a food, beverage, or wine preparation device and a program for controlling of said food, beverage, or wine preparation device;
loading starting components of said into said food, beverage, or wine preparation device;
activating said food, beverage, or wine preparation device;
controlling operation of said food, beverage, or wine preparation device;
interacting with said user by requesting said user to evaluate characteristics of said food, beverage, or wine by using at least one human sense selected from the group consisting of a sense of taste, visual evaluation, sense of smell, and sense of touch of said food, beverage, or wine for obtaining results of product characteristic evaluation; and
either discontinuing further processing if said results are satisfactory, or adjusting said process and repeating said process until said results are satisfactory.

11. The method of claim 10, wherein said food, beverage, or wine preparation device further comprises: at least one executing mechanism, and at least one sensor for measuring characteristics of said food, beverage, or wine; a central processing unit connected to said at least one executing mechanism and at least one sensor; a data input unit connected to said central processing unit; and a data output unit connected to said central processing unit.

12. The method of claim 11, comprising the step of using said food, beverage, or wine preparation device for making a wine.

13. The method of claim 12, wherein said at least one executing mechanism is selected from the group consisting of a cooler, a heater, a cooler-heater, and a press.

14. The method of claim 13, wherein said at least one sensor is selected from the group consisting of a temperature sensor, a sugar-content sensor, and a pH sensor.

15. The method of claim 10, wherein said data processing unit is selected from the group consisted of a computer, an embedded micro-processor, and a PDA.

16. The method of claim 15, wherein said data input unit is a keyboard and said data output unit is a display.

17. The method of claim 14, wherein said data processing unit is selected from the group consisted of a computer, an embedded micro-processor, and a PDA.

18. The method of claim 17, wherein said data input unit is a keyboard and said data output unit is a display.

19. The method of claim 16, wherein said step of requesting said user to evaluate characteristics of said food, beverage, or wine comprising displaying a set of questions on said display, said questions involving the use of at least one human sense selected from the group consisting of a sense of taste, visual evaluation, sense of smell, and sense of touch of said food, beverage, or wine.

20. The method of claim 19, wherein said questions occur as a result of interaction between said at least one sensor and said program.
